(19) United States
(12) Patent Application Publication
(10) Pub. No.: US 2009/0165434 A1
(43) Pub. Date: Jul. 2, 2009

(54) Easy-to-Assemble Link Chain

(76) Inventor: Burkhard Poppeck, Duisburg (DE)

Correspondence Address: ROBERT W. BECKER & ASSOCIATES, 707 HIGHWAY 333, SUITE B, TIJERAS, NM, 87059-7507, US

(21) Appl. No.: 12/339,307

(22) Filed: Dec. 19, 2008

(30) Foreign Application Priority Data
Jun. 20, 2006 (DE) 20 2006 009 595.0

(51) Int. Cl. F16G 13/07

(52) U.S. Cl. 59/85

(57) ABSTRACT

A link chain, as a conveying chain, comprised of endless chain strands produced by connecting terminal inner links of two preassembled chain portions with at least one securement outer link via chain bolts preassembled at a first end on the securement outer link and/or the terminal inner links. A second free end of each chain bolt is inserted into an associated opposite outer link and is provided with a stepped extension extending beyond the associated opposite outer link through which it is inserted. Each extension has a diameter less than a diameter of openings provided on links for receiving chain bolts that are to be pressed or deformed thereon, and also has a formation for a removable attachment of a securement device serving for temporary assembly of the link chain portions with one another. For final assembly, the chain bolts are fixedly connected to associated outer links by a bolt press that effects pressing of bolt shafts, which adjoin the extensions, into the openings of the associated opposite outer links.

The invention relates to a link chain as a conveying chain, especially for plate conveyors, bucket conveyors, or similar conveying means, comprising at least two chain strands that are disposed parallel to one another and are each formed of a sequence of inner links and outer links, whereby the respectively oppositely disposed inner links and outer links are connected by a respective common chain bolt that extends through the links in associated openings and is secured to the outer links by a pressing or deformation process, and whereby for producing endless chain strands by connecting the terminal inner links of two preassembled portions of the link chain, at least one securement outer link is provided that can be connected with the terminal inner links of the two portions via chain bolts that are preassembled on the securement outer link and/or on a terminal inner link.

Such a connection arrangement for the connection of two portions of a link conveying chain with one another is described in WO 2005/095236, and in particular with a plate conveyor in conjunction with respectively identically constructed plates that are carried by the link chain and mutually overlap in the conveying direction of the plate conveyor in their base region and also overlap with their vertically extending side flanges. For the connection of the individual chain strands, the terminal link member of one of the portions is comprised of two outwardly projecting terminal inner links, and the terminal link member of the other portion that is to be connected therewith is comprised of an inner link and of a terminal outer link that is supported on one side by the chain bolts of the second terminal link member and projects outwardly from the terminal link member, and a securement outer link is provided that by means of a bore formed on one of its ends can be placed upon the chain bolt that carries the terminal outer link, and via a chain bolt that is preassembled on its other end extends through both of the outwardly projecting terminal inner links of the terminal link member of the first portion as well as through the free end of the outwardly projecting terminal outer link of the second terminal link member of the other portion. During the assembly of the plate conveyor, the securement outer link is inserted between those terminal inner links of the two portions that are opposite one another in the associated chain strand, whereby during the insertion already a pressing or deformation of the chain bolts is effected, and thus a fixed connection of the securement outer link with the terminal links of the portions of the conveying chains that are to be connected is established.

The known link chain has the drawback that the link chain is delivered in numerous portions, for example of only two meters length, and is assembled at the use site to form the endless chain strand. Since a special bolt press is required for the final assembly, it is not always possible to utilize this bolt press at every location where the conveying unit is to be assembled, so that these days heavy lifting elements are required in order to move the link chain during its assembly. It is therefore an object of the present invention to further develop a link chain having the aforementioned features in such a way that its final assembly is facilitated.

The realization of this object, including advantageous embodiments and further developments of the invention, result from the content of the patent claims, which follow this description.

The basic concept of the invention is that the chain bolts, which are preassembled with one end thereof to links, on its free end, which can be inserted into the respectively associated other outer link, is provided with an extension that is stepped beyond the thickness of the outer links that are used, and that has a smaller diameter than the diameter of the openings provided on the links for receiving the chain bolts that are to be pressed or deformed thereon, as well as a formation for the removable attachment of a securement means that serves for the temporary assembly of the portions of the link chain with one another, and in that, for the final assembly of the link chain, the chain bolts can be fixedly connected to the associated outer links by means of a bolt press that effects a pressing of the bolt shafts of the chain bolts that inwardly adjoin the extensions into the openings of the outer links. The invention has the advantage that the individual portions of the link chain, by using, at the use site, securement outer links provided with inventively embodied chain bolts, or due to the special configuration of the chain bolts disposed in the connection region, can first preliminarily or temporarily be manually joined together to form an endless chain strand that can be placed on the drive mechanism without having to use heavy specialized equipment. The finally preassembled link chain can then, by means of its chain drive mechanism, be moved past a bolt press that is set up at a suitable location of the conveying unit. Here, the removable securing means are first again removed from the chain bolts that are disposed in the connection region, and then the pertaining chain bolts are pressed into the links by using the bolt press provided therefor, so that a fixed connection of the appropriate portions of the link chain results.

With regard to the design of the removable connection of the securement outer link with the two portions of the link chain that are to be connected, pursuant to alternative embodiments of the invention the chain bolts can be provided on the outer side of their extensions with a respective groove for receiving a retaining ring, or an end face of the end of the extension of the chain bolt can be provided with a screw hole for receiving a screw that secures a securing disk to the chain bolt.

Pursuant to a first embodiment of the invention, with regard to the arrangement of the corresponding securement outer link, the terminal link member of one of the portions is comprised of two outwardly projecting terminal end links, and the end link member of the other portion that is to be connected therewith is comprised of an inner link and a terminal outer link that is supported on one end of the chain bolt of the terminal link member of the other portion and projects outwardly from the other portion, and the securement outer link, via a bore formed at one of its ends, can be placed upon the chain bolt that supports the terminal outer link, and via a chain bolt that is preassembled at its other end, extends through the two outwardly projecting terminal inner links of the first portion as well as the free end of the outwardly projecting outer link of the second portion. To this extent, this embodiment of the configuration of the two terminal link members corresponds to the portions that are to be connected having terminal inner links and a projecting terminal outer link that projects on one side in the configuration of the chain connection described in the aforementioned WO 2005/095236.

However, pursuant to an alternative embodiment of the chain bolts of the present invention, both terminal link members of the interconnected portions can respectively be comprised of two outwardly projecting terminal inner links, and two securement outer links can be provided that, for the connection of the portions, can be inserted into the two chain strands for the connection of their terminal inner links.

For this purpose, pursuant to different embodiments of the chain connection having two securement outer links, the one securement outer link supports two chain bolts preassembled on it, and the opposite securement outer link is provided with two bores for receiving the bolt shafts of the chain bolts preassembled on the securement outer link, or the two securement outer links each have a bore formed at one of their ends and at the other end each have a preassembled chain bolt, and can be inserted into the two chain strands of the portions in a mirror-inverted manner and can be connected with one another for the temporary assembly and for the final assembly in that the chain bolt respectively preassembled on one securement outer link can be inserted into the bore respectively formed on the securement outer link.

To bring about the symmetrical construction on the chain bolts that are each to be pressed or deformed, so that the bolt press can be uniformly designed and can be installed in any desired position relative to the chain strand, it is proposed that the chain bolt that is preassembled on the securement outer link as well as the chain bolt that supports the terminal outer link each, via an end portion, project externally beyond the securement outer link and the terminal outer link, whereby the length of the end portions corresponds to the dimension of the extensions of the chain bolts. In this way, the bolt portions that correspondingly extend beyond the outer links also serve as an end stop for the pressing process, after which the interconnected individual links are movable relative to one another.

An embodiment of the invention, which will be described subsequently, is shown in the drawing, in which:

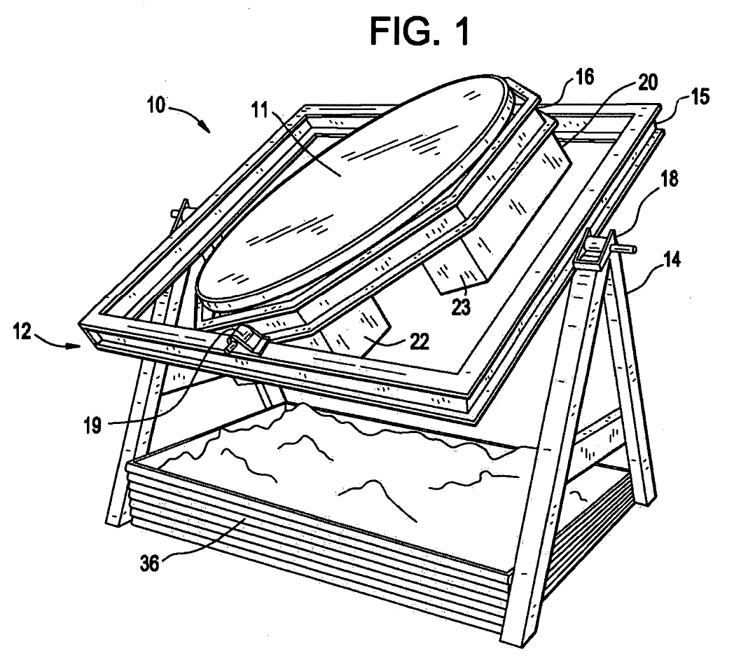

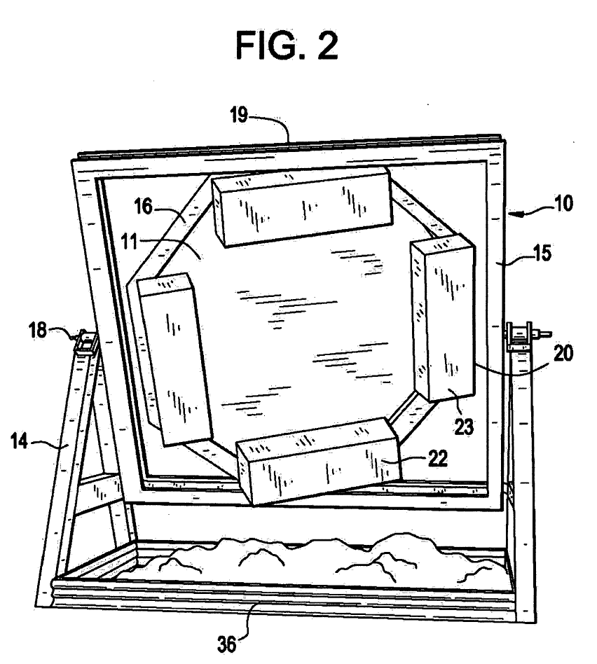

FIG. 1 shows two portions of a link chain that are to be joined together, including the pertaining securement outer link in the position suitable for the insertion of the securement outer link,

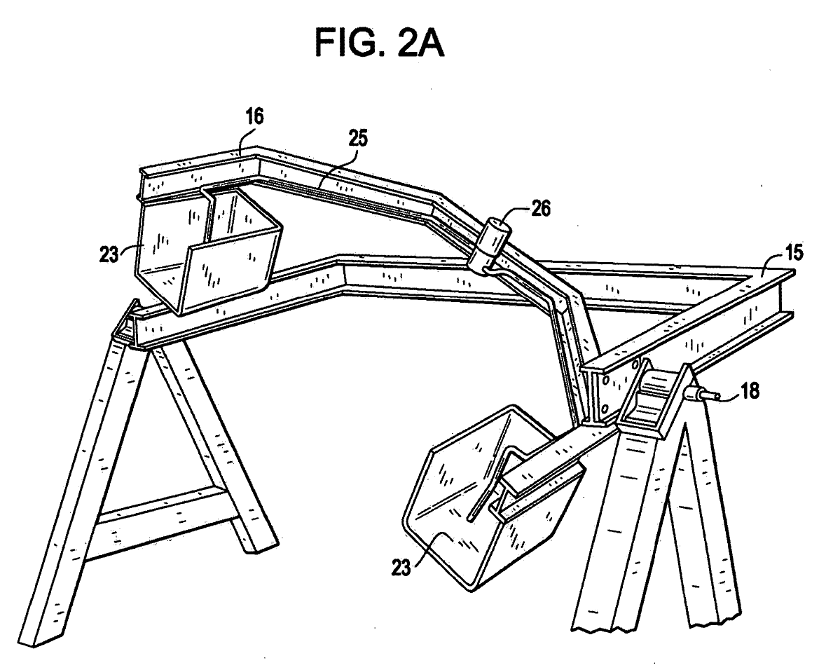

FIG. 2 shows the subject matter of FIG. 1 with the securement outer link inserted for the purpose of preassembly,

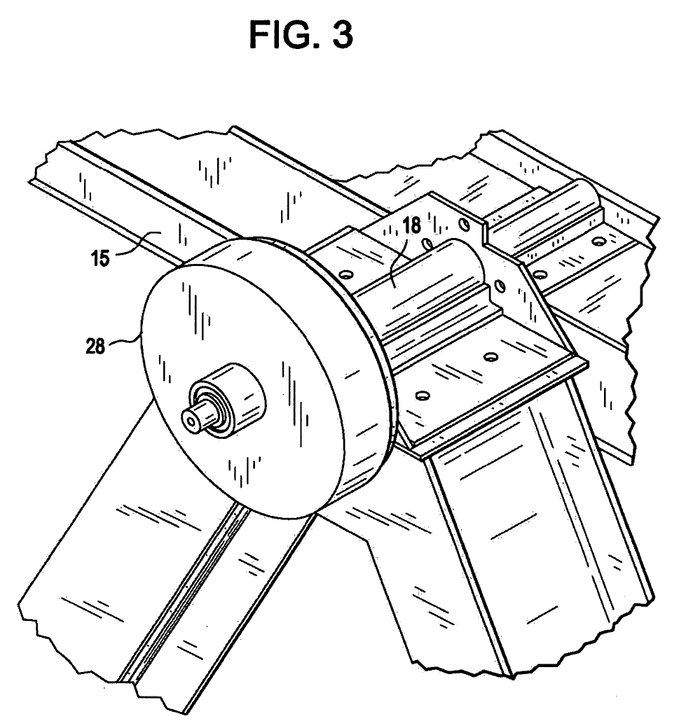

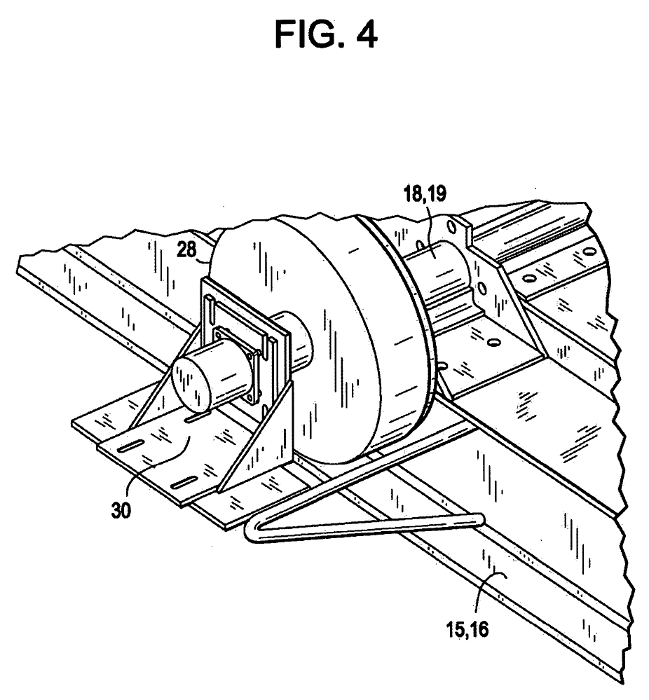

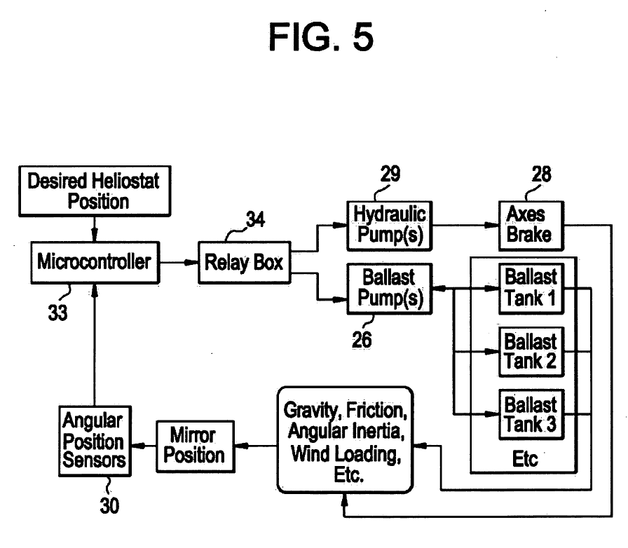

FIG. 3 shows the subject matter of FIG. 2 in the final, non-detachable assembled position of the securement outer link.

The link chain illustrated in the drawing is comprised of two chain strands 10 that are disposed parallel to one another, whereby each chain strand 10 is formed of a sequence of inner links 11 and outer links 12. The inner links 11 and outer links 12 of the two chain strands 10 that are disposed across from one another are respectively interconnected by sleeves 13, which connect the inner links 11, and chain bolts 14 that are inserted into the sleeves 13 through associated openings of the outer links 12, whereby the bolt shafts 30 of the chain bolts 14 are respectively pressed into the openings formed in the outer links 12. The inner links 11 and outer links 12 of one of the two chain strands 10 respectively support an attachment bracket 15 for the securement of the further components of the conveying means that are carried by the link chain, for example for the attachment of buckets or plates when the link chain is used for a bucket conveyor or for a plate conveyor.

As shown in FIG. 1, the right portion 16 of a link chain, as a terminal link member, is provided with two outwardly projecting terminal inner links 17 that are disposed parallel to one another and are hence associated with both of the chain strands 10.

The opposite portion 18, which is illustrated on the left side of the drawing and is to be connected with the right portion 16, as a terminal link member is provided with one terminal outer link 19, which is associated with only one chain strand 10, and one end of which is connected to the last chain bolt 20 of the portion 18 and thus projects freely outwardly.

Furthermore illustrated is the closure or securement outer link 22 that is provided for connecting the first portion 16 with the second portion 18. One end of the securement outer link is provided with a non-illustrated opening for placement upon the associated chain bolt 20 of the second portion 18 that has the outwardly projecting terminal outer link 19, and the other end of the securement outer link is provided with a pressed-in chain bolt 23 via which the securement outer link 22, after the moving together of the two portions 16 and 18 as shown in FIG. 1, can be inserted into the outwardly projecting inner links 17, that is, into the sleeve 13 disposed between them. This form of the securement outer link 22 essentially conforms 10 the securement link already described in the aforementioned WO 2005/095236.

The two chain bolts 20 and 23 have a special configuration, which is different from that of the remaining chain bolts 14 of the link chain, to the extent that the free ends of the chain bolts 20, 23, which are insertable into the associated terminal outer link 19 and the securement outer link 22, are provided with a stepped extension 25, which has a smaller diameter than the diameter of the openings formed in the terminal outer link 19 and the securement outer link 22, so that the terminal securement link 22 can be manually inserted into the pertaining chain strand 10. Formed on the outer ends of each of the respective extensions 25 of the two chain bolts 20, 23 is a groove 26 for the removable receipt of a non-illustrated retaining ring that can be disposed in the groove 26.

FIG. 2 shows the temporary or preliminary assembly position of the link chain, which is effected by the insertion of the securement outer link 22 that is to be manually carried out. The securement outer link 22 is inserted between the chain strands 10 by placing the opening found on the left end of the securement outer link 22 upon the associated extension 25 of the chain bolt 20, while the chain bolt 23 found on the securement outer link 22 is inserted through the sleeve 23 that connects the terminal inner links 19, and its extension 25 comes to rest in the bore formed at the end of the terminal outer link 19. In this position, visible from FIG. 2, respective retaining rings are inserted into the two grooves 26 of the extensions 25 of the chain bolts 20, 23, resulting in a temporary connection of the first portion 16 and the second portion 18 of the link chain. As a consequence of the temporary chain connection visible from FIG. 2, the link chain, via its own drive mechanism, can now be moved past a non-illustrated bolt press, with the aid of which this preliminary assembly is converted into the final assembly, which is illustrated in FIG. 3. For this purpose, the retaining rings are removed from the grooves 26 of the two chain bolts 20 and 23, and by means of the bolt press the bolt shafts 30 of the bolts that adjoin the extensions 25 are now pressed into the openings of the respective outer links 19 and 23. So that with regard to the use of the bolt press a symmetry of the structure of the chain connection results, a respective end portion 27 of the chain bolt 23, which is preassembled on the securement outer link 25, as well as of the chain bolt 20 that carries the terminal outer link, projects externally beyond the securement outer link 22 and the terminal outer link 19, whereby the length of the end portions 27 corresponds to the dimension of the extensions 25 of the chain bolts 20, 23.

Although not further illustrated, if the terminal outer link 19 preassembled in the pertaining chain strand 10 is eliminated, two securement outer links that are loosely inserted and cooperate with one another can be provided. In this connection, pursuant to a first embodiment, one of the securement outer links can support two chain bolts preassembled thereon, while the opposite securement outer link has two bores in which the chain bolts supported by the other securement outer link engage. Alternatively, two equally constructed securement outer links can be provided that each have a bore and each have a chain bolt preassembled thereon can be inserted into the two respective chain strands in a mirror-inverted manner relative to one another, and can be interconnected not only in a preliminary assembly position but also in the final assembly position.

The features of the subject matter of these documents disclosed in the preceding description, the patent claims, the abstract and the drawing can be important individually as well as in any combination with one another for realizing the various embodiments of the invention.

1-8. (canceled)

9. A link chain as a conveying chain, comprising:
at least two chain strands (10) that are disposed parallel to one another, wherein each of said chain strands (10) is formed of a sequence of inner links (11) and outer links (12);
first chain bolts (14) for connecting said inner links (11) and said outer links (12) that are respectively disposed across from one another, wherein said first chain bolts (14) extend through openings provided in said inner links (11) and said outer links (12) and are secured to said outer links (12) via a pressing or deformation; and
at least one securement outer link (22) for producing endless chain strands by connecting terminal ones (17) of said inner links (11) of two preassembled portions (16,18) of said link chain, wherein said at least one securement outer link (22) is connected to said terminal inner links (11, 17) of said two preassembled chain portions (16, 18) via second chain bolts (20, 23) that are preassembled at a first end on at least one of said at least one securement outer link (22) and said terminal inner links (11, 17), further wherein a second free end of each of said second chain bolts (20, 23), which free end is inserted into an associated opposite outer link (19, 22), is provided with a stepped extension (25) that extends beyond a thickness of the associated opposite outer link (19, 22) through which it is inserted, further wherein said extensions (25) have a diameter that is less than a diameter of openings provided on links for receiving said second chain bolts (20, 23) that are to be pressed or deformed thereon, further wherein said extensions (25) are provided with a formation (26) for a removable attachment of a securement means that serves for a temporary assembly of the link chain portions (16, 18) with one another, and wherein, for a final assembly of said link chain, said second chain bolts (20, 23) are fixedly connected to associated ones of said outer links (19, 22) by means of a bolt press that effects a pressing of bolt shafts (30) of said second chain bolts (20, 23), which bolt shafts (30) inwardly adjoin said extensions (25), into said openings of said associated opposite outer links (19, 22).

10. A link chain according to claim 9, wherein said formation (26) is in the form of a groove provided on the outer end of said extensions (25) of said second chain bolts (20, 23), and wherein each groove (26) serves for receiving a retaining ring.

11. A link chain according to claim 9, wherein said formation is in the form of a screw hole provided at an end face of an end of said extensions (25) of said second chain bolts (20, 23), and wherein said screw hole serves for receiving a screw for securing a retaining disk on said second chain bolt (20, 23).

12. A link chain according to claim 9, wherein a terminal link member of one portion (16) of said link chain portions (16, 18) is comprised of two outwardly projecting terminal inner links (17), further wherein a terminal link member of the other portion (18) of said link chain portions (16, 18), which is to connected to said one portion (16), is comprised of two of said inner links (11) and of one terminal outer link (19) that is supported on one end of said second chain bolt (20) of said terminal link member of the other portion (18) and projects outwardly form said other portion (18), further wherein one securement outer link (22) is provided that has a bore formed at one end thereof, further wherein said bore is placed upon said second chain bolt (20) that supports said terminal outer link (19), further wherein an opposite end of said securement outer link (22) has a preassembled second chain bolt (23), and wherein said preassembled second chain bolt (23) extends through both of said outwardly projecting terminal inner links (17) of said one portion (16) as well as through a free end of said outwardly projecting terminal outer link (19) of said other portion (18).

13. A link chain according to claim 9, wherein both of said terminal link members of said link chain portions (16, 18) that are to be connected to one another are respectively comprised of two outwardly projecting terminal inner links (11, 17), and wherein two securement outer links (22) are provided that, for connection of said link chain portions (16, 18), are Inserted into the two chain strands (10) for connection of their terminal inner links (11, 17).

14. A link chain according to claim 13, wherein one of said securement outer links (22) supports two second chain bolts (23) preassembled thereon, and wherein the opposite one of said securement outer links (22) is provided with two bores for receiving the bolt shafts (30) of said second chain bolts (23) preassembled on the other securement outer link (22).

15. A link chain according to claim 13, wherein each of said securement outer links (22) has a bore at one end thereof, and at an opposite end thereof is provided with a preassembled second chain bolt (23), further wherein said two securement outer links (22) are inserted into the two chain strands (10) of said link chain portions (16, 18) in a mirror-inverted manner and are interconnected for both a temporary assembly and for final assembly in that for each of said securement outer links (22) the second chain bolt (23) preassembled thereon is inserted into the bore of the other securement outer link (22).

16. A link chain according to claim 9, wherein each of said second chain bolts (20, 23) is provided with an end portion (27) that projects beyond said associated outer link (19, 22), and wherein a length of said end portion (27) corresponds to a length of said extension (25) of each of said second chain bolts (20, 23).
